(19) United States
(12) Patent Application Publication
(10) Pub. No.: US 2008/0266393 A1
(43) Pub. Date: Oct. 30, 2008

(54) INFRA-RED CLOSED CIRCUIT TELEVISION CAMERA HAVING IR LED MOVING ACCORDING TO THE MOTION OF LENS

(76) Inventor: Min Soo Park, Kyungki-do (KR)

Correspondence Address: MARC E. HANKIN, ESQ., 11414 THURSTON CIRCLE, LOS ANGELES, CA, 90049, US

(21) Appl. No.: 11/868,944

(22) Filed: Oct. 8, 2007

(30) Foreign Application Priority Data
Apr. 30, 2007 (KR) 10-2007-42042

(51) Int. Cl. H04N 5/33; H04N 9/47

(52) U.S. Cl. 348/143; 348/164

(57) ABSTRACT

The invention relates to an Infra Red Closed Circuit Television (IR CCTV) surveillance camera equipped with IR LEDs that can irradiate IR light on a subject, properly illuminating the entire subject according to the distance to the subject, by moving the IR LEDs back from the subject and retracting the LEDs into reflecting sections when the subject is at a far distance, to thereby concentrate the IR light at a distance via a focused, concentrated, and/or collimated beam. The camera moves forward the IR LEDs toward the subject when the subject is nearby, such that the LEDs protrude from the reflecting sections to provide a dispersed beam to properly illuminate the entire nearby subject.

### FIELD OF INVENTION

This invention relates, generally, to Infra-Red Closed Circuit Television (IR CCTV) surveillance cameras; more particularly to IR CCTV surveillance cameras equipped with IR Light Emitting Diodes (LEDs) that can irradiate IR light on a subject.

This application claims priority to the Korean Application for Patent Number 10-2007-42042 filed on Apr. 30, 2007, for The Infra-Red Closed Circuit Television Having IR LED Moving According to the Motion of Lens, the contents of which are incorporated herein by reference in their entirety.

### BACKGROUND

Generally, CCTV (Closed Circuit Television) surveillance cameras are installed along walls or ceilings of public buildings, financial institutions, or residential areas, viewing and recording situations for the purpose of monitoring the passers by.

Infra-Red Closed Circuit Television (IR CCTV) surveillance cameras enable recording when there is no visible light, during nighttime or in dark places. The IR CCTV surveillance camera is equipped with IR LEDs around its lens sections to emit IR light, making it possible to capture images at nighttime.

FIG. 1 illustrates a known IR CCTV surveillance camera of the prior art. It generally includes an LED board 10 fixed on the case 2, emitting IR light for irradiating subjects.

But, the known IR CCTV surveillance camera of FIG. 1 using known technology has the following problems.

When the distance to a subject from the camera is too far or too close from the camera, images are taken by moving the locations of the lens (in other words, so-called zoom in/zoom out that adjusts lens distance) using the distance adjuster installed in the CCTV camera. However, there is no technology that can move back and forth the IR LEDs 11 to or from the subject depending on the distance to the subject.

So, there has been no technology developed that can controllably irradiate IR light from the IR LEDs 11, depending on the distance to the subject, by light concentrating or dispersion.

More particularly, there has not been any technologies developed so far that could irradiate by concentrating an IR beam to arrive at the subject when the subject is at a far distance, or when the subject is at a close distance, by dispersing the beam over the entire subject.

Therefore, in the case of the IR CCTV surveillance camera using known technology, whether the subject was at a far or close distance, the same dispersed beam had to be irradiated at all times, so approximately 150 individual IR LEDs were needed to produce sufficient lighting of distant objects. So many IR LEDs, illuminated all the time, resulted in the problem of increasing production cost for known IR CCTV surveillance cameras.

In addition, for the above IR LEDs, many numbers of IR LEDs were needed, creating the problem of an awkward appearance.

### SUMMARY OF THE INVENTION

This invention relates to an Infra Red Closed Circuit Television (IR CCTV) surveillance camera equipped with IR LEDs that can irradiate IR light on a subject, while minimizing the loss of IR light that irradiates regardless of the distance to the subject, by moving back the IR LEDs from the subject when the subject is at a far distance, and moving forward the IR LEDs toward the subject when the subject is at a close distance. The IR LEDs inter-lock with the movement of the lens. Embodiments of the invention are appropriate for reducing the numbers of IR LEDs and thus leading to reduced production costs.

According to an embodiment of this invention, the IR CCTV camera includes a case, a lens mount that is installed inside the case that includes a lens, a distance adjuster that is installed in the lens mount and that adjusts the distance to a subject by moving the lens frontward and rearward via rotation, and a focus adjuster that adjusts focus by enlarging or reducing a lens aperture via rotation and that is installed in the lens mount symmetrical to the distance adjuster. The IR CCTV surveillance camera further includes an LED plate equipped with IR LEDs configured to interact with a distance adjusting gear that is fixed and connected on an outer rim of the distance adjuster. The distance adjusting gear is configured to include teeth arranged in a radial shape extending in a perpendicular direction from the distance adjusting gear. The distance adjusting gear includes a rotator that is fixed on a forward side of the distance adjusting gear such that it rotates as a single unit with the distance adjusting gear according to the rotation of the distance adjusting gear. A frontward and rearward mover slidingly engages the rotator, and is configured to slidingly move forward and rearward via a cam effect by rotation of the rotator. The LED board accordingly moves back and forth as a single unit with the frontward and rearward mover by connecting to the frontward and rearward mover. The above configuration therefore has the benefit of reducing the number of IR LEDs required for proper illumination.

Embodiments of the IR CCTV surveillance camera equipped with IR LEDs that move according to the motion of the lens can irradiate IR light on the whole subject, while minimizing the loss of IR light that irradiates regardless of the distance to the subject, by moving back the IR LEDs from the subject when the subject is at a far distance, and moving forward the IR LEDs toward the subject when the subject is at a close distance.

Embodiments of the IR CCTV surveillance camera equipped with IR LEDs that move according to the motion of the lens are capable of reducing the required numbers of IR LEDs to lower production cost.

Other features and advantages of this invention will become apparent from the following description of several embodiments of the invention, taken in conjunction with the accompanying drawings, which illustrate, by way of example, the principles of the invention.

### BRIEF DESCRIPTION OF THE DRAWINGS

FIG. 1 is a perspective view of the exterior configuration of a known IR CCTV surveillance camera of the prior art.

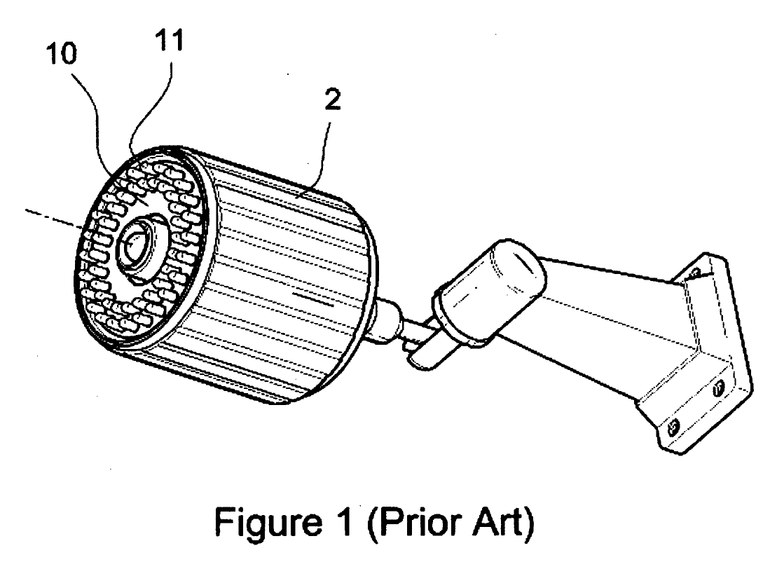

FIG. 2 is an exploded perspective view of an embodiment of an IR CCTV surveillance camera according to the present invention.

FIG. 3 is a partial cross-section lateral view of an embodiment of an IR CCTV surveillance camera according to the present invention.

FIG. 4 is a frontal view of the embodiment illustrated in FIG. 3.

FIG. 5 is an exploded perspective view of a rotator and frontward and rearward mover of the embodiment illustrated in FIG. 3.

FIG. 6 is a lateral view of the rotator and frontward and rearward mover illustrated in FIG. 5.

FIG. 7 is a side view of an embodiment of the IR CCTV surveillance camera according to the present invention.

FIG. 8 is a side view of an embodiment of the IR CCTV surveillance camera according to the present invention.

### DRAWINGS

### Reference Numerals

102: Case
110: Lens mount
112: Distance adjuster
114: Focus adjuster
122: Distance adjusting gear
122a: Gear measurement
130: Rotator
130′: Whorl
140: Frontward and rearward mover
140a: Round body
140b: Mover whorl
140c: Connector rib
150: LED board
150a: Insertion hole
150b: Center hole
151: IR LEDs
160: Reflection plate
161: LED hole
162: Reflection section
165: Supporting pole
166: Spring

### DETAILED DESCRIPTION OF THE DRAWINGS

In the following detailed description of various embodiments of the invention, numerous specific details are set forth in order to provide a thorough understanding of various aspects of one or more embodiments of the invention, however, one or more embodiments of the invention may be practiced without these specific details. In other instances, well-known methods, procedures, and/or components have not been described in detail so as not to unnecessarily obscure aspects of embodiments of the invention.

In the following description, certain terminology is used to describe certain features of one or more embodiments of the invention. For instance, “surveillance camera” or “camera” refers to any type of “optical device,” and “IR LEDs” refers to any device that is used to produce light, including lamps, individual LEDs, and arrays of multiple LEDs.

The following is an exemplary usage of the infra-red closed circuit television camera having IR LEDs moving according to the motion of the lens described in detail by reference to the attached Figures.

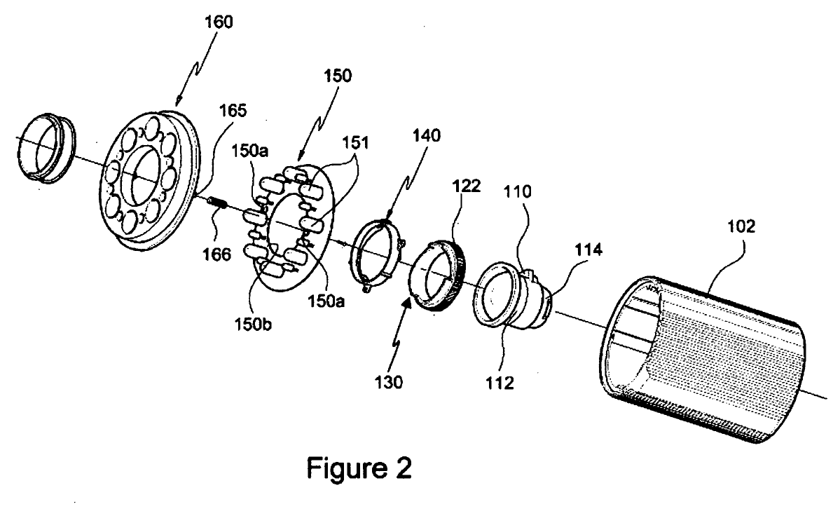

According to an embodiment of this invention as illustrated in FIG. 2, the IR CCTV camera includes a case 102, a lens mount 110 that is installed inside the case 102 that includes a lens, a distance adjuster 112 that is installed in the lens mount 110 and that adjusts the distance to a subject by moving the lens frontward and rearward via rotation, a focus adjuster 114 that adjusts focus by enlarging or reducing a lens aperture via rotation and that is installed in the lens mount 110 opposite the distance adjuster 112. The IR CCTV surveillance camera further includes, separately installed forward of the lens mount 110, an LED plate 150 equipped with IR LEDs configured to interact with a distance adjusting gear 122 that is fixed and connected on an outer rim of the distance adjuster 112. The distance adjusting gear 122 is configured to include teeth arranged in a radial shape extending in a perpendicular direction from the distance adjusting gear 122. The distance adjusting gear 122 includes a rotator 130 that is fixed on a forward side of the distance adjusting gear 122 such that it rotates as a single unit with the distance adjusting gear 122 according to the rotation of the distance adjusting gear 122. Frontward and rearward mover 140 slidingly engages the rotator 130, and is configured to slidingly move forward and rearward via a cam effect by rotation of the rotator 130. The LED board 150 accordingly moves back and forth as a single unit with the frontward and rearward mover 140 by connecting to the frontward and rearward mover 140. The above configuration therefore has the benefit of reducing the number of IR LEDs 151 required for proper illumination.

The IR CCTV surveillance camera equipped with IR LEDs that move according to the motion of the lens features an elasticity adhesion mechanism that provides elasticity between the rotator 130 and the frontward and rearward mover 140, to engage the frontward and rearward mover 140 with the rotator 130.

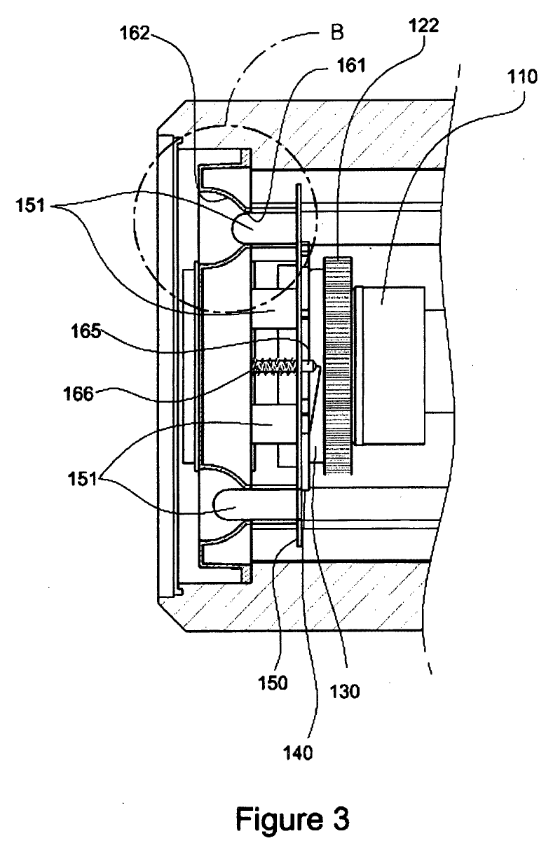

The elasticity adhesion mechanism of the IR CCTV surveillance camera is installed in the case 102 and features a reflection plate 160 that increases the efficiency of IR light concentration irradiated by the IR LEDs on a subject. The reflection plate 160 is installed in the case 102 via supporting poles 165 (see FIGS. 3, 7 and 8) that are formed to protrude in equal intervals through the LED plate 150 and into the rear of the reflection plate 160. Springs 166 provide elasticity between the LED board 150 and the reflection plate 160, by being interposed between the rear side of the reflection plate 160 and the front side of the LED board 150, extendable along the supporting poles 165. The LED board 150 features insertion holes 150a formed for insertion of the supporting poles 165 through the LED board.

The reflection plate 160 includes multiple LED holes 161 (see FIGS. 3, 4, 7 and 8) for insertion of the IR LEDs 151 therethrough. The LED holes 161 include a reflection section 162 formed to disperse the IR light while irradiating, or concentrate the IR light while irradiating, according to the forward and rearward positioning of the IR LEDs 151 relative to the reflection plate 160 and the reflection sections 162. The reflection section 162 symmetrically widens around the LED hole 161, expanding open toward the front of the reflection plate 160, having an increasing radius of curvature along the forward direction.

The following is a detailed description of an embodiment of an IR CCTV surveillance camera equipped with IR LEDs that move according to the motion of the lens, including a preferred operational example based on the attached Figures.

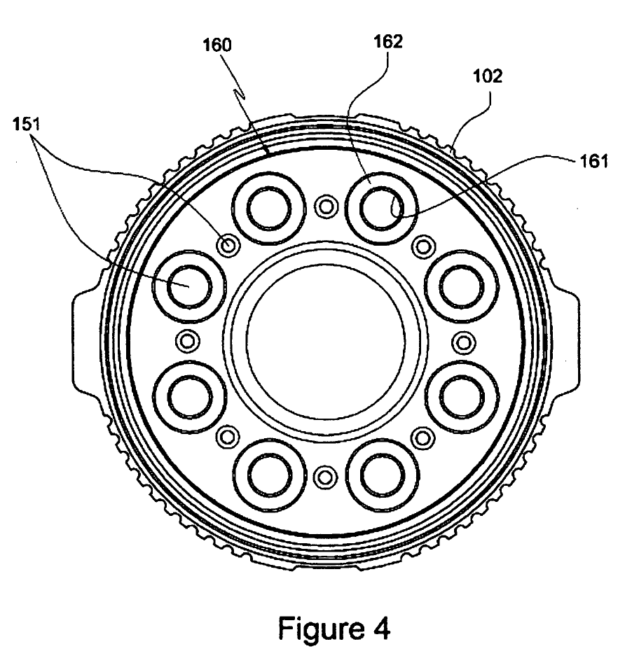

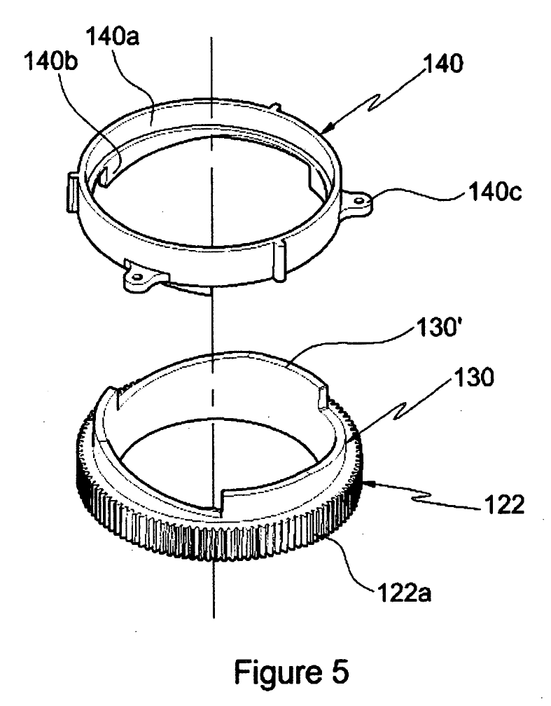

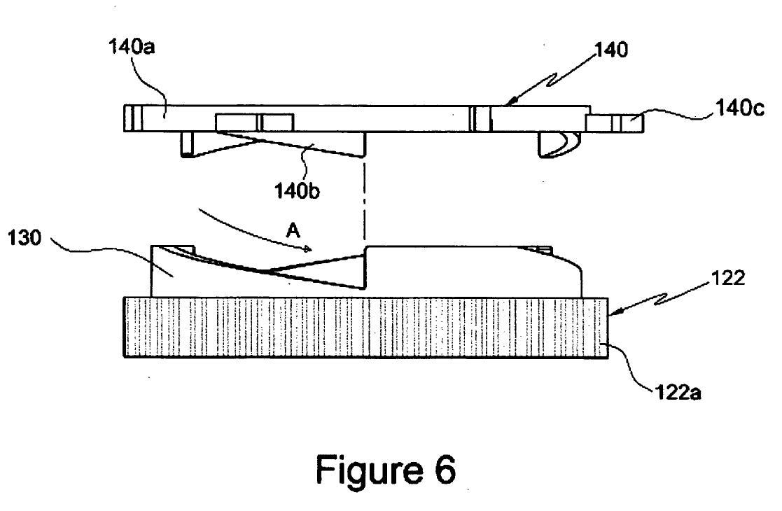

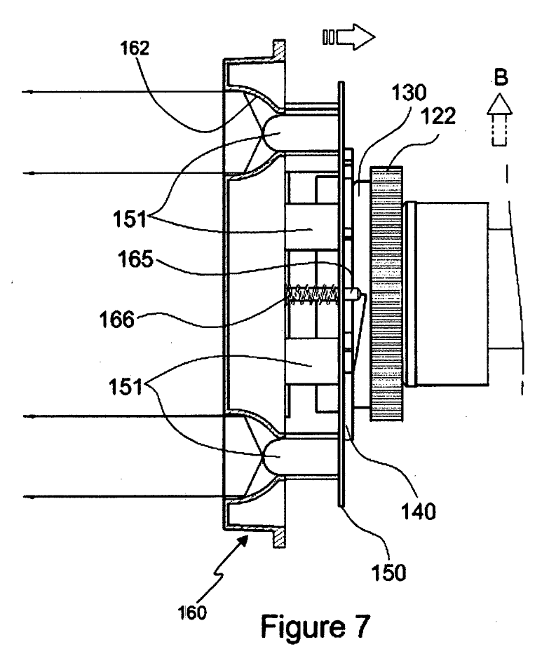

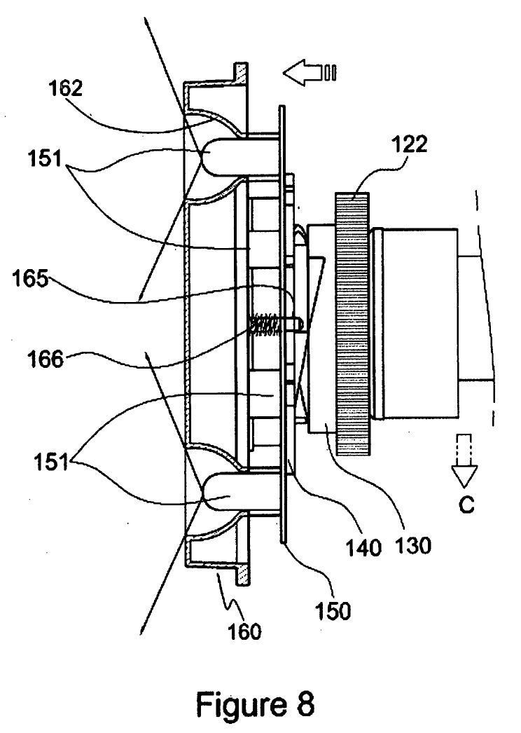

FIG. 2 illustrates an exploded perspective view of an embodiment of an IR CCTV surveillance camera equipped with IR LEDs that move according to the motion of the lens. FIG. 3 illustrates a partial cross-section lateral view of an embodiment of an IR CCTV surveillance camera according to the present invention. FIG. 4 is a frontal view of the embodiment illustrated in FIG. 3, FIG. 5 is an exploded perspective view of a rotator and frontward and rearward mover of the embodiment illustrated in FIG. 3, and FIG. 6 is a lateral view of the rotator and frontward and rearward mover illustrated in FIG. 5. FIGS. 7 and 8 are side views of embodiments of the IR CCTV surveillance camera according to the present invention.

As illustrated in FIGS. 2-8, embodiments of the IR CCTV surveillance camera are equipped with IR LEDs 151 that move according to the motion of the lens. The camera includes a case 102, a lens mount 110 that is installed inside the case 102 and that mounts the lens, and distance adjuster 112 that adjusts the distance to the subject by moving the lens back and forth via rotation and that is installed on the lens mount 110. Focus adjuster 114 is installed in the lens mount 110 symmetrical to the distance adjuster 112, and adjusts focus by enlarging or reducing the lens aperture via rotation. The IR CCTV surveillance camera is configured to include the LED board 150 that is equipped with Infra-Red Light Emitting Diodes (IR LEDs) and installed on the front side (i.e., on a side in the direction of illumination, towards where a subject is, as used throughout the specification) of the lens mount 110. The camera further includes distance adjusting gear 122, rotator 130, and the frontward and rearward mover 140 (see also FIGS. 3-8).

The distance adjusting gear 122 is connected and fixed on the exterior rim of the distance adjuster 112, and gear teeth 122a (see FIGS. 5-6) are formed in a perpendicular radial configuration.

As illustrated in greater detail in FIG. 5, the rotator 130 is connected and fixed to the distance adjusting gear 122. The rotator 130 rotates as a single unit with the distance adjusting gear 122 according to the rotation of the distance adjusting gear 122.

The rotator 130 is created in a spiral form along the frontward direction on the distance adjusting gear 122, and is configured as multiple whorls 130′ in equal intervals.

The whorl 130′ is formed, as illustrated in FIGS. 5 and 6, extending from the distance adjusting gear 122, and created in a spiral form including a slope along a circumferential direction corresponding to the slopes extending from the frontward and rearward mover 140.

The frontward and rearward mover 140 interfaces slidably with the rotator 130, and moves back and forth in a cam method according to the interaction with the whorls 130′ and the rotation of rotator 130.

The frontward and rearward mover 140 is formed to closely conform to the whorl 130′ in appearance, to move the frontward and rearward mover 140 backward and forward in a cam movement according to the rotation of the rotator 130.

As illustrated in FIGS. 5 and 6, the frontward and rearward mover 140 includes a round body 140a forming a ring shape, with mover whorl 140b having a spiral form conforming with the whorl 130′, extending from the rear of the round body 140a. Frontward and rearward mover 140 includes connector ribs 140c that connect with the LED board 150.

The LED board 150 is installed on the frontward and rearward mover 140, and moves backward and forward as a single unit with the frontward and rearward mover 140.

The frontward and rearward mover 140 is elastically pushed against the rotator 130 to prevent separation therebetween. The frontward and rearward mover 140 (and LED board 150) is moved with respect to the reflection plate 160, which increases the efficiency of IR light concentration irradiated by the IR LEDs 151 on the subject by positioning the reflection plate 160 in the case 102 forward of the LED board 150 (i.e., in the direction of illumination). Multiple supporting poles 165 (see FIGS. 7 and 8) protrude forward in equal intervals through the LED board 150 into the rear of the reflection plate 160. The supporting poles 165 include multiple springs 166 that provide elasticity for mounting the LED board 150.

LED board 150 includes insertion holes 150a (see FIG. 2) formed to allow the supporting poles 165 to be inserted into and pass through the LED board 150.

As illustrated in FIG. 4, reflection plate 160 includes multiple LED holes 161 for insertion of the IR LEDs 151 therethrough. And, reflection section 162 is formed to symmetrically surround the LED holes 161, to disperse and irradiate, or to concentrate and irradiate, IR light that is emitted from the IR LEDs 151 according to the backward and forward motion and positioning of the IR LEDs 151, to vary the radius of curvature of the reflection section 162 corresponding to the location of the IR LEDs 151 in the LED holes 161.

As illustrated in FIGS. 7 and 8, the reflection section 162, to disperse and irradiate, or concentrate and irradiate, IR Light emitted from the IR LEDs 151, expands open toward the front of the reflection plate 160, enlarging the radius of curvature in a forward direction from the LED hole 161. The LED hole 161 has a tapered form along its interior, providing a concave shape in tapering into the LED hole 161.

The following is a description about the operational functions of the IR CCTV surveillance camera, equipped with IR LEDs that move according to the motion of the lens, having the structure and functions described above.

As illustrated in FIG. 7, IR LEDs 151 are moved rearward (i.e., retracted), to create an IR beam by the IR LEDs situated toward the rear of the reflection section 162, concentrating and/or collimating the beam appropriate for illuminating a distant subject.

As a result, even when subjects are at far distances, IR light can be irradiated on the subjects with sufficient intensity, while using only a relatively small number (e.g., 22-24 in this operation example) of IR LEDs 151.

When the illuminated subject is at a far distance, to enlarge images of the subject, the distance adjusting gear 122 is rotated in the C direction as illustrated in FIG. 8 to zoom in (in other words, telephoto), by moving out of the position illustrated in FIG. 8 and into the position illustrated in FIG. 7. Rotator 130 thereby rotates in the C direction along with the distance adjusting gear 122.

If the rotator 130 rotates in the C direction, the frontward and rearward mover 140 moves backward via rotation of the rotator whorl 130′ and a force from the springs 166, causing the LED board 150 and IR LEDs 151 to move backward as well.

If the IR LEDs 151 retreat as described above, IR light can be irradiated and concentrated at far distances. IR Light can be irradiated without spreading out the beam, which means that IR light can be irradiated and concentrated on distant subjects, without dispersing the beam, by the configuration of the reflection plate 160.

When the subject is at a close distance, to take images of the subject, the distance adjusting gear 122 is rotated in the B direction, from the zoomed-in position illustrated in FIG. 7, to a zoomed-out position (in other words, wide angle) as illustrated in FIG. 8. The rotator 130 also rotates in the B direction along with the rotation of the distance adjusting gear 122.

When the rotator 130 rotates in the B direction, the frontward and rearward mover 140 moves forward by the rotation of the rotator whorl 130′, and if the frontward and rearward mover 140 moves forward, the LED board 150 also moves forward, so the IR LEDs 151 move forward as well.

If the LEDS 151 move forward as described above and illustrated in FIG. 8, the IR LEDs 151 disperse IR light, enabling illumination over the entire subject. IR light is irradiated on the close distance subject by smoothly dispersing a wider beam via the configuration of the reflection plate 160.

As illustrated in FIG. 8, if IR LEDs 151 move forward, they are situated in front of the reflection section 162, enabling IR light to irradiate on the whole subject at a close distance by dispersing the IR beam without using the reflection section 162 to concentrate the entire beam, as illustrated in FIG. 8.

As a result, even when subjects are at close distances, IR light can be irradiated on the entire subject using only a relatively small number (e.g., 22-24 were used in this operational example) of IR LEDs 151.

The actual operational example of the above device is only exemplary of the above design's technological concept, and modified operational examples are within the scope of this device's technology.

### BENEFITS OF THE INVENTION

Embodiments of the IR CCTV surveillance camera equipped with IR LEDs that move according to the motion of the lens with the configuration and functions as described above have the following benefits.

First, when a subject is at a far distance, the camera has the benefit of moving back the IR LEDs 151 away from the subject, and moving forward the IR LEDs 151 toward the subject, according to the motion of the lens, so that IR LEDs 151 that are retracted from the subject are located toward the rear of the reflection section 162, which enables IR light to irradiate on the whole subject by collecting and concentrating IR Light without dispersing it.

As a result, the light beam arrives on the distant subject by being concentrated, so it has the benefit of minimizing the IR light that is not concentrated on the subject.

Second, when a subject is at a close distance, the camera has the benefit of moving IR LEDs 151 forward toward the subject according to the motion of the lens, so that the IR LEDs 151 moved forward toward the subject are located in front of the reflection section 162, so IR light irradiates on the nearby subject by dispersing, and as a result, IR light irradiates on the whole subject.

Third, in the prior art technology, about 150 IR LEDs were used, but with embodiments of this invention, only 22-24 of them can be used for nighttime image taking, so it has the benefit of lowering the surveillance camera's production cost.

Fourth, by substantially reducing the numbers of IR LEDs, the camera has the benefit of substantially improving the camera's appearance.

While multiple embodiments are disclosed, still other embodiments of the present invention will become apparent to those skilled in the art from the foregoing detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive. Also, the reference or non-reference to a particular embodiment of the invention shall not be interpreted to limit the scope of the invention. Various embodiments of the invention remain useable in tandem or combination of one another.

What is claimed is:

1. An Infra-Red Closed Circuit Television surveillance camera, comprising:
a case;
a lens mount installed inside the case that mounts a lens;
a distance adjuster installed in the lens mount and configured to adjust the distance to a subject by moving the lens frontward toward the subject and rearward away from the subject, via rotation;
a focus adjuster that adjusts focus by enlarging or reducing the lens aperture by rotation, installed in the lens mount opposite the distance adjuster;
an LED plate equipped with Infra-Red LEDs, separately installed forward of the lens section;
a distance adjusting gear connected and fixed to an exterior rim of the distance adjuster, including gear teeth formed in a perpendicular radial configuration;
a rotator fixed to a forward side of the distance adjusting gear such that it rotates along with the rotation of the distance adjusting gear;
a frontward and rearward mover that slidably interfaces the rotator to thereby move backward and forward via a cam effect according to the rotation of the rotator; and
an LED board that connects to the frontward and rearward mover and that moves backward and forward along with the backward and forward movement of the frontward and rearward mover.

2. The camera of claim 1, further comprising:
an elasticity adhesion mechanism configured to provide elasticity between the rotator and the frontward and rearward mover to ensure contact between the frontward and rearward mover and the rotator.

3. The camera of claim 2, further comprising:
a reflection plate configured to increase the efficiency of IR light concentration emitted by the IR LEDs and concentrated on a subject, installed in the case proximal to and forward of the LED board;
a plurality of supporting poles formed to protrude at equal intervals through insertion holes in the LED board to a rear of the reflection plate, the plurality of supporting poles including multiple springs for providing an elastic force to the LED board.

4. The camera of claim 3, wherein:
the rotator comprises multiple rotator whorls formed on the distance adjusting gear in a spiral having equal intervals and extending forward from the distance adjusting gear; and
wherein the frontward and rearward mover is formed to conform with the rotator whorls, and moves backward and forward via a cam effect according to the rotation of the rotator whorls.

5. The camera of claim 1, wherein:
the rotator comprises multiple rotator whorls formed on the distance adjusting gear in a spiral having equal intervals and extending forward from the distance adjusting gear; and
wherein the frontward and rearward mover is formed to conform with the rotator whorls, and moves backward and forward via a cam effect according to the rotation of the rotator whorls.

6. The camera of claim 3, wherein:
The reflection plate includes a plurality of LED holes configured to enable the IR LEDs to be inserted therethrough in a forward direction; and
each of the LED holes includes a reflection section that is formed to disperse or concentrate IR light that is emitted by the IR LEDs in accordance with the frontward and rearward position of the IR LEDs as the IR LEDs symmetrically emerge from and are retracted into the LED holes, wherein the radius of curvature of the reflection section enlarges along the forward direction from the LED hole.
